(19) United States
(12) Patent Application Publication
(10) Pub. No.: US 2007/0096424 A1
(43) Pub. Date: May 3, 2007

(54) Turning restriction device for a handle

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/240,499

(22) Filed: Oct. 3, 2005

(51) Int. Cl. B62K 21/00

(52) U.S. Cl. 280/272

(57) ABSTRACT

A turning restriction device for a handle includes a wheel strut and a handle tube. The wheel strut is inserted into the handle tube. The wheel strut comprises a block protruding from a lower section. The handle tube comprises a sleeve. The sleeve has an arcuate trough and the handle tube has an arcuate recess corresponding to the block so that the block is confined to move or to slide along the arcuate recess and within the defined area by the arcuate trough.

### BACKGROUND OF THE INVENTION

1. Field of the Invention

The present invention relates to a turning restriction device for a handle, and more particularly to a device confining turning of a handle applied to a kick scooter, bike, tricycle, or a children's playing cart.

2. Description of the Related Prior Art

The turning device for a children's playing cart on the market comprises a handle for the rider to turn a front wheel when riding the cart. The handle is provided with a front tube to secure a front wheel thereat. By turning the handle, the front wheel turns simultaneously.

This design doesn't confine a range of turning. When the rider makes a turn, he/she may loose their balance and fall easily.

### SUMMARY OF THE INVENTION

It is the primary object of the present invention to provide a turning restriction device for a handle, which is safe to a rider.

It is another object of the present invention to provide a turning restriction device for a handle, which is endurable.

It is a further object of the present invention to provide a turning restriction device for a handle, which is easy to install.

### BRIEF DESCRIPTION OF THE DRAWINGS

FIG. 1 is an exploded view of the present invention;

FIG. 2 is a perspective view of the present invention, and

FIG. 3 is a top view of the present invention.

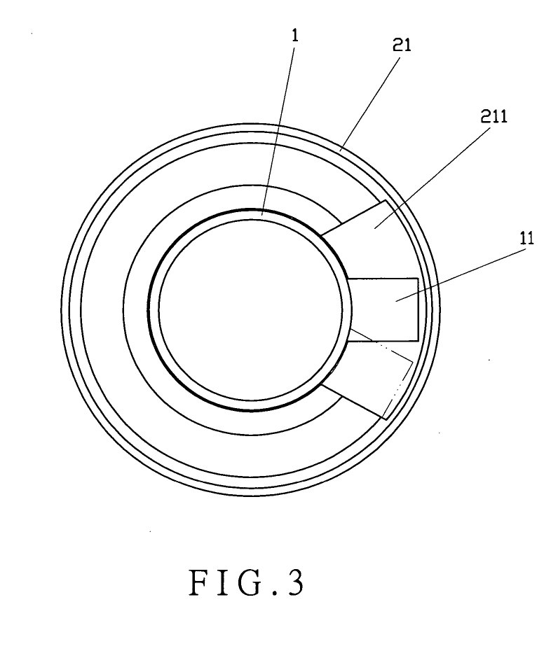

### DETAILED DESCRIPTION OF THE PREFERRED EMBODIMENT

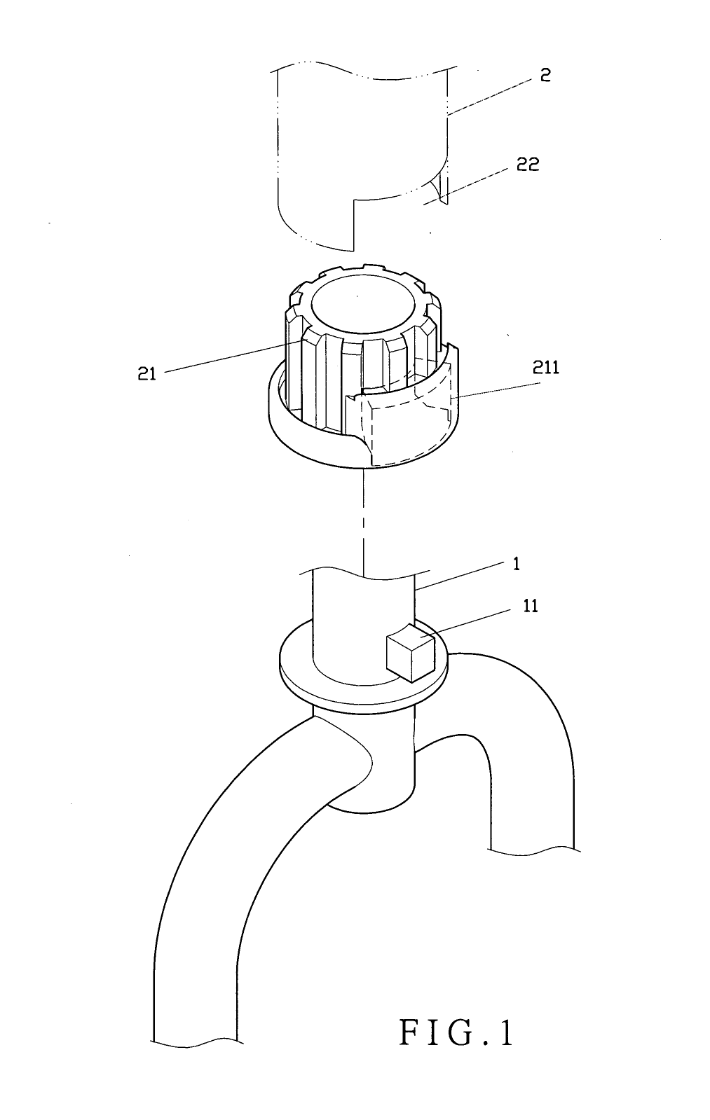

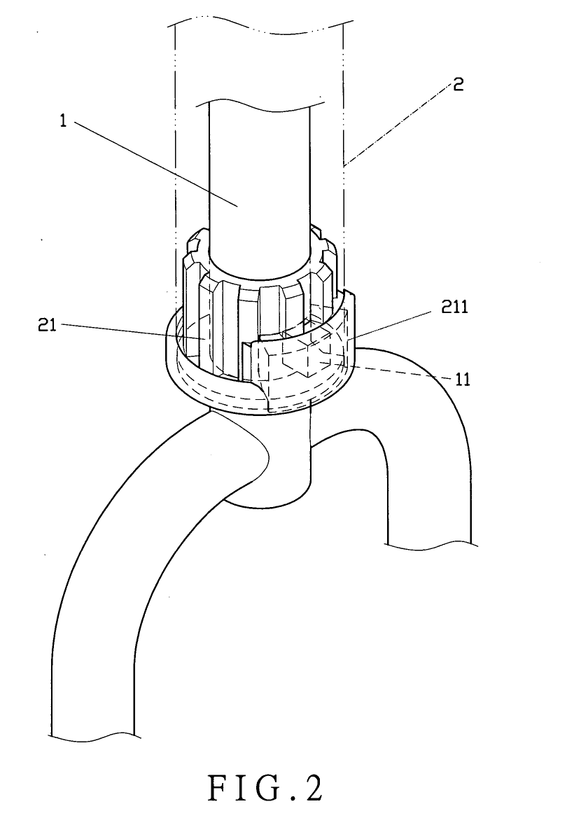

As shown in FIGS. 1 and 2, the present invention comprises a wheel strut 1 and a handle tube 2. The wheel strut 1 is inserted into the handle tube 2.

The wheel strut 1 has a block 11 protruding from a lower section thereof. The handle tube 2 is provided with a sleeve 21. The sleeve 21 has an arcuate trough 211 and the handle tube 2 has an arcuate recess 22 for the block 11 to slide therein.

When turning the handle towards either direction, the block 11 of the wheel strut 1 will slide along and within the arcuate recess 22 of the handle tube 2 and the arcuate trough 211 of the sleeve 21. Upon the block 11 reaches to the end of the arcuate trough 211, the turning movement will be stopped thereat so that the handle is confined to turn within a pre-determined range to keep the cart in a safety status. All of the material is made of metal, which is endurable.

I claim:

1. A turning restriction device for a handle comprising a wheel strut and a handle tube, wherein said wheel strut is inserted into said handle tube, and characterized by:
said wheel strut comprising a block protruding from a lower section, said handle tube comprising a sleeve, said sleeve comprising an arcuate trough and said handle tube comprising an arcuate recess for said block to slid therein.
